(19) United States
(12) Patent Application Publication
(10) Pub. No.: US 2009/0102934 A1
(43) Pub. Date: Apr. 23, 2009

(54) IMAGING APPARATUS AND CONTROLLING METHOD THEREOF

(75) Inventor: Chao-Lien Tsai, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/110,557

(22) Filed: Apr. 28, 2008

(30) Foreign Application Priority Data
Oct. 23, 2007 (CN) 200710202216.6

(51) Int. Cl. H04N 5/232

(52) U.S. Cl. 348/211.6; 348/E05.024

(57) ABSTRACT

An exemplary imaging apparatus includes a body, a rotation unit, and an image control unit. The body includes a camera module configured for sensing an image. The body can be attached to the rotation unit. The image control unit includes an image capturing module, a setting module, a retrieving module, and a processing module. The image capturing module is configured for capturing the image. The setting module is configured for setting a predetermined figure and a predetermined position. The retrieving module retrieves data of the predetermined figure and the predetermined position. The processing module controls the rotation unit to rotate until the predetermined figure is detected at the predetermined position in the image. If the predetermined figure is detected at the predetermined position in the image, the imaging apparatus is controlled to take a picture.

### TECHNICAL FIELD

The present invention relates to an imaging apparatus and a controlling method thereof, and specifically, to an imaging apparatus and a controlling method that can arrange an object to be photographed to a predetermined position in an image.

### BACKGROUND

Cameras with a delay timer have been around for a long time to enable users to include themselves in pictures they take. At present, when the delay timer is employed, image capture is executed by an automatic focusing (AF) operation performed after a time delay.

In use, time delay images present a challenge to the user. It may be difficult to ensure proper focus of the image, and there is some urgency in rushing to get properly positioned, and in fact it may be difficult to determine a best position for the picture. Therefore, it is desired to provide a reliable method for taking pictures using a delay timer.

### SUMMARY

In accordance with an exemplary embodiment, an imaging apparatus is provided. The imaging apparatus comprises a body, a rotation unit, and an image control unit. The body comprises a camera module configured for sensing an image. The body can be attached to the rotation unit. The image control unit comprises an image capturing module, a setting module, a retrieving module, and a processing module. The image capturing module is configured for capturing the image sensed by the camera module. The setting module is configured for setting a predetermined figure and a predetermined position. The retrieving module retrieves data of the predetermined figure and the predetermined position. The processing module controls the rotation unit to rotate until the predetermined figure is detected to be at the predetermined position in the image. Once the predetermined figure is detected to be at the predetermined position in the image, the imaging apparatus is controlled to take a picture.

In accordance with another exemplary embodiment, a controlling method for an imaging apparatus configured for taking a picture is provided. The imaging apparatus comprises a rotation unit and a camera module for sensing an image. The controlling method comprises steps: setting a predetermined figure and a predetermined position; capturing the image sensed by the camera module; the rotation unit rotating the imaging apparatus until the predetermined figure is detected at the predetermined position; and controlling the imaging apparatus to take a picture.

Other novel features and advantages will be drawn from the following detailed description of at least one preferred embodiment, when considered in conjunction with the attached drawings.

### BRIEF DESCRIPTION OF THE DRAWINGS

Many aspects of the present imaging apparatus and controlling method can be better understood with reference to the following drawings. The components in the drawings are not necessarily drawn to scale, the emphasis instead being placed upon clearly illustrating the principles of the present image previewing system and method. Moreover, in the drawings, like reference numerals designate corresponding parts throughout the several views.

FIG. 1 is a block diagram of an imaging apparatus in accordance with an exemplary embodiment.

FIG. 2 is a functional block diagram of an image control unit of the imaging apparatus of FIG. 1.

FIG. 3 is a schematic diagram of an image sensed by a camera module when a processing module detects a predetermined figure according to the exemplary embodiment.

FIG. 4 is a schematic diagram of an image sensed by the imaging apparatus when the processing module detects the predetermined figure located at a predetermined position after the imaging apparatus is rotated to a specific angle.

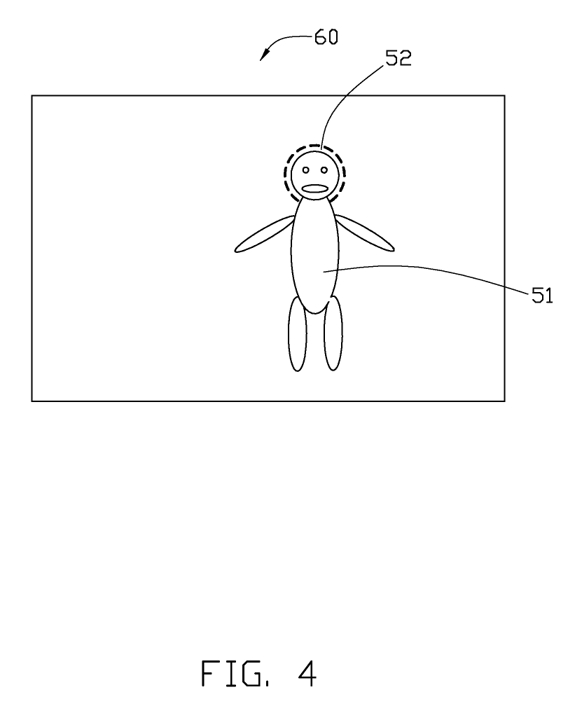

FIG. 5 is a flow chart of a controlling method of taking pictures with the imaging apparatus of FIG. 1.

### DETAILED DESCRIPTION OF THE EMBODIMENTS

Embodiments of the present imaging apparatus and controlling method will now be described in detail below and with reference to the drawings.

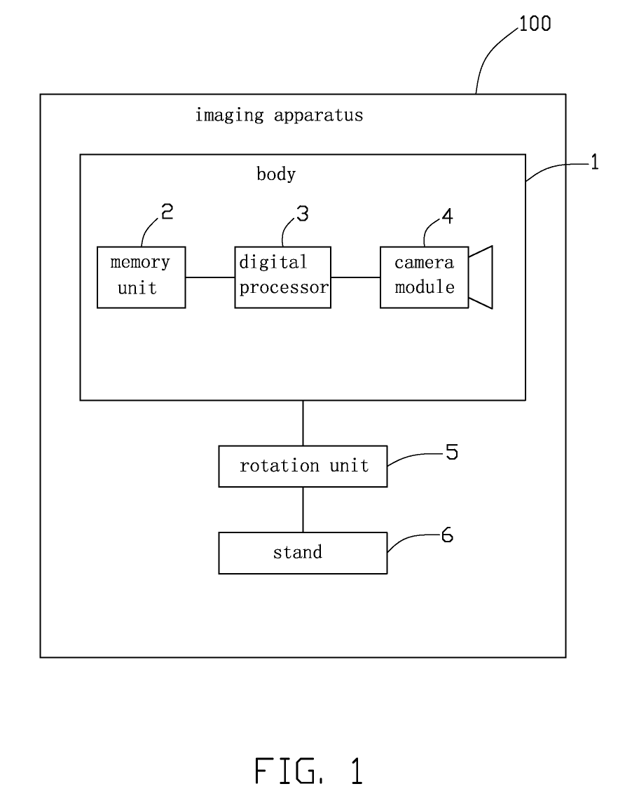

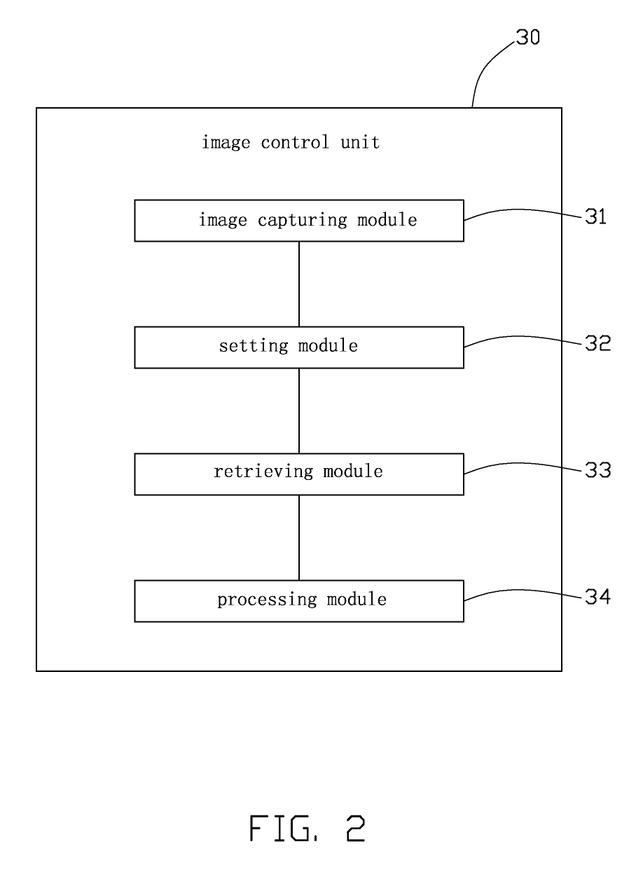

Referring to FIG. 1, a block diagram of an imaging apparatus 100 in accordance with an exemplary embodiment is shown. The imaging apparatus 100 is a camera device such as a digital camera or a digital video recorder. The imaging apparatus 100 comprises a body 1, a rotation unit 5, and a stand 6. A camera module 4, a digital processor 3, and a memory unit 2 are installed inside the body 1. An image control unit 30 (shown in FIG. 2) is stored in the memory unit 2. The digital processor 3 controls the image control unit 30 to drive the rotation unit 5 to rotate the body 1 relative to the stand 6. The digital processor 3 also controls the camera module 4 to take pictures.

The body 1 is attached to the rotation unit 5. The rotation unit 5 is installed on the stand 6. The rotation unit 5 can rotate relative to the stand 6 and thus position the body 1 to be at a position providing a desired camera angle.

Referring to FIG. 2, a functional block diagram of the image control unit 30 of the imaging apparatus 100 according to the exemplary embodiment is shown. The image control unit 30 comprises an image capturing module 31, a setting module 32, a retrieving module 33, and a processing module 34.

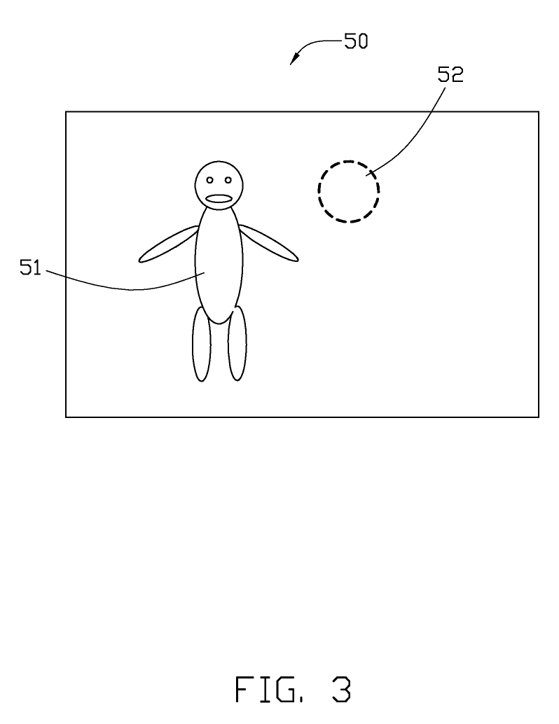

Referring to FIG. 3, the image capturing module 31 is configured for capturing an image 50 sensed by the camera module 4. The image 50, for example, can be a self-portrait of the user 51.

The setting module 32 is configured for setting a predetermined figure and a predetermined position 52. The predetermined figure can be a certain portion or total portion of an object to be photographed. The predetermined position 52 is a desired final position of the predetermined figure in a taken picture. For example, if the object to be photographed is the user who operates the camera, the face of the user can be set as the predetermined figure. The predetermined figure and the predetermined position 52 are both stored in the memory unit 2.

The retrieving module 33 is configured for retrieving the predetermined figure and the predetermined position 52 stored in the memory unit 2. The processing module 34 receives data of the predetermined figure and the predetermined position 52. The processing module 34 is configured for finding a figure substantially identical to the predetermined figure to be at the predetermined position of the image captured by the image capturing module 31. If the predetermined figure is not detected at the predetermined position 52 of the image 50, the processing module 34 controls the rotation unit 5 of the imaging apparatus 100 to rotate seeking a camera angle from which the predetermined figure is found to be at the predetermined position 52 in the image 50. The body 1 attached with rotation unit 5 simultaneously rotates to the specific angle. Subsequently, the imaging apparatus 100 takes pictures. Understandably, the specific angle can be zero.

Referring to FIG. 2˜4, in one embodiment, the predetermined position 52 is set to be in a middle area of the taken picture. The camera module 4 repeatedly senses the image 50. The image capturing module 31 captures the image 50 from the camera module 4. The processing module 34 receives data of the predetermined figure and the predetermined position 52 stored in the memory unit 2. The processing module 34 finds the predetermined figure in the image 50. For example, the predetermined figure is set to be a human face pattern, and then a face detection function can be performed by the processing module 34 to acquire the human face in the image 50.

If the processing module 34 cannot find the predetermined figure at the predetermined position 52 of the image 50, the processing module 34 controls the rotation unit 5 to rotate to a next camera angle and the camera module 4 senses a next image 60. The image capturing module 31 captures the next image 60 and the processing module 34 again checks for the predetermined figure at the predetermined position 52. The above-mentioned processes can be repeated for a given number of times until the processing module 34 finds the camera angle from which the predetermined figure can be found at the predetermined position 52 in a current next image 60.

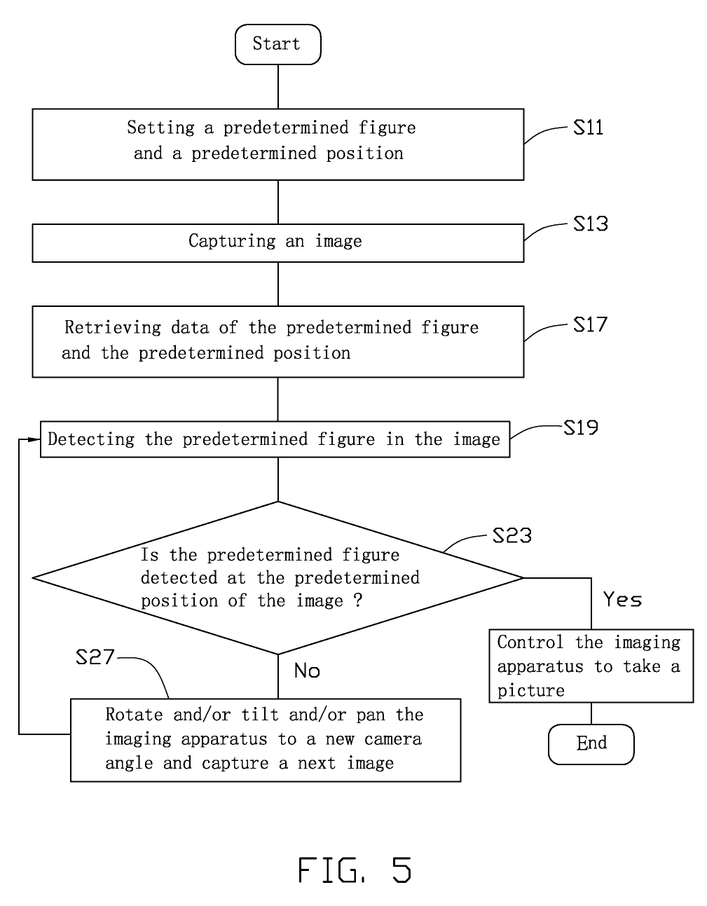

Referring to FIG. 5, a method for controlling the imaging apparatus 100 to take pictures is shown. The method comprises steps:
STEP S11: setting a predetermined figure and a predetermined position. In an exemplary embodiment, data of the predetermined figure and the predetermined position can be set by a setting module 32 of the imaging apparatus 100 and stored in the memory unit 2.
STEP S13: capturing an image.
STEP S17: retrieving data of the predetermined figure and the predetermined position. In the preferred embodiment, the image 50 is sensed by the camera module 4 and then captured by the image capturing module 31. The processing module 34 receives data of the predetermined figure and the predetermined position from the memory unit 2.
STEP S19: detecting the predetermined figure in the image.
STEP S23: if the predetermined figure is detected to be at the predetermined position of the image captured by the image capturing module 31, controlling the imaging apparatus to take a picture; if the predetermined figure is not detected at the predetermined position of the image, execute step S27.
STEP S27: rotate and/or tilt and/or pan the imaging apparatus to a new camera angle and capture a next image. Return to STEP S19.

The present embodiment automatically adjusts the position of a target object in a taken picture. It facilitates the user of the camera to capture self-portraits with the use of a delay timer.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. An imaging apparatus, comprising:
a body comprising a camera module for sensing an image;
a rotation unit, the body being attached to the rotation unit; and
an image control unit, comprising:
an image capturing module configured for capturing the image sensed by the camera module;
a setting module configured for setting a predetermined figure and a predetermined position;
a retrieving module configured for retrieving data of the predetermined figure and the predetermined position; and
a processing module configured for controlling the rotation unit to rotate the body until the predetermined figure is detected to be at the predetermined position.

2. The imaging apparatus as claimed in claim 1, wherein when the predetermined figure is detected at the predetermined position, the processing module is utilized for controlling the imaging apparatus to take a picture.

3. The imaging apparatus as claimed in claim 1, further comprising a stand configured for receiving the rotation unit thereon.

4. The imaging apparatus as claimed in claim 1, further comprising a memory unit configured for storing data of the predetermined figure and the predetermined position.

5. The imaging apparatus as claimed in claim 1, wherein the predetermined figure is a human face pattern.

6. The imaging apparatus as claimed in claim 1, wherein the predetermined figure is a portion of a human face pattern.

7. A controlling method for an imaging apparatus configured for taking a picture, the imaging apparatus comprising a rotation unit and a camera module for sensing an image, the method comprising:
setting a predetermined figure and a predetermined position;
capturing the image sensed by the camera module;
detecting the predetermined figure in the image;
the rotation unit rotating the imaging apparatus until the predetermined figure is detected at the predetermined position if the predetermined figure is not detected at the predetermined position; and
controlling the imaging apparatus to take a picture.

8. The controlling method as claimed in claim 7, wherein the imaging apparatus further comprises a processing module and the controlling method further comprises: the processing module detecting the predetermined figure in the image.

9. The controlling method as claimed in claim 7, wherein the imaging apparatus further comprises a processing module and the controlling method further comprises:
the rotation unit rotating the imaging apparatus to a new camera angle;
the capturing module capturing a next image; and
the processing module detecting the predetermined figure in the next image.

10. The controlling method as claimed in claim 7, wherein the image apparatus further comprises a memory unit and the controlling method further comprises:
storing data of the predetermined figure and the predetermined position in the memory unit; and
retrieving data of the predetermined figure and the predetermined position.
